(19) United States
(12) Patent Application Publication
(10) Pub. No.: US 2006/0190549 A1
(43) Pub. Date: Aug. 24, 2006

(54) Multi-media information device network system

(76) Inventors: Kouichi Teramae, Ishikawa (JP); Seiichi Kaneda, Ishikawa (JP); Junichi Uemura, Ishikawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/565,556

(22) PCT Filed: Jul. 23, 2004
(86) PCT No.: PCT/JP04/10488

§ 371 Date: Jan. 23, 2006

(51) Int. Cl. G06F 17/30; G06F 15/16

(52) U.S. Cl. 709/208; 707/10

(57) ABSTRACT

One of the multimedia information devices connected to a network is set as a master, which generates and manages an integrated directory list (41) for all files in the network. In order to implement a function of the master described above, each of the devices has programs (31-34) for keeping and synchronizing the integrated directory list (41) and a program (37) for retrieving and displaying. Moreover, there is provided a program (35) for master/slave switching control so as to select an optimal master when withdrawal of the master from the network or connection of a new device occurs. In this way, it is possible to provide unitary management of files kept by the multimedia information devices connected to a home network at a low cost and without imposing a load to the network.

### FIELD OF THE INVENTION

The present invention relates to a network system for multimedia information devices, and more particularly, relates to a network system for multimedia information devices having means for managing files which enables sharing and use of the files, which are kept in multimedia information devices connected to a network, particularly a home network, for example.

### BACKGROUND OF THE INVENTION

Recently, personal computers and broadband communication lines have been prevailed to such an extent that they are residentially available. In addition, number of homes which employ a network system connecting a plurality of personal computers has been increasing. Furthermore, multimedia information devices, such as PDA (Personal Digital Assistance), CD (Compact Disk) player, DVD (Digital Versatile Disk) player, digital camera, digital video camera and digital video recorder for TV broadcasting, have flooded into homes. Under these circumstances, there have occurred many cases where data generated by recording with a device (this type of data which is stored in a memory device such as a disk is called a file) is playbacked or stored by other multimedia information devices including a personal computer.

It has been known that it is possible to share files mutually and use them with commercially available personal computers, which are connected to each other by a network. For example, it is possible for a personal computer to use data via a network which is recorded by a digital video camera connected to another personal computer as a peripheral device.

Patent documents 1 and 2 disclose examples of systems, which share files among a plurality of information devices connected to each other by a network. In these systems, each information device connected to the network individually keeps a shared file and synchronizes it continuously. Synchronization of a file is meant to represent making contents of a shared file consistent among different information devices, each of which keeps the shared file. This means that a file is kept by a plurality of information devices and there is no chance of inconsistency among files. In this way, if a file is damaged in an information device, it is possible to reproduce the damaged file with a file kept in another information device. Methods disclosed in these documents have features of remarkably high reliability.

In systems disclosed by the patent documents 1 and 2, synchronization of the file is carried out each time a file is generated, changed or deleted. This leads to a greater load imposed on a network due to transmission of the file required by synchronization. In the patent document 1, relaxation of load for the file is implemented by distributing a differential file, which only covers a changed portion of the file.

In the patent document 2, a home network is assumed. Features of a home network are that it is not impossible to anticipate when an information device is turned on or off. When an information device is turned off and updating of a shared file is coincidentally being carried out in another information device, it is not possible to synchronize a file kept in the turned-off device. This will result in discrepancy in synchronization between these files. The patent document 2 discloses a method to compensate the discrepancy in synchronization.

Another example of method to provide unitary management of files among a plurality of information devices connected by a network is introduction of a server. The server here is meant to represent a computer which is dedicated to managing of shared files. The server keeps all the files to be shared in the network. This method does not require either keeping a file individually in the information devices or synchronizing files, different from the examples described in the patent documents 1 and 2. For this reason, it is possible to prevent memory capacity of a whole system from increasing. In addition, load imposed on the network due to synchronization will not be induced.

Patent document 1: JP2000-222268 A (see paragraphs 0015-0041, FIG. 1-FIG. 3)

Patent document 2: JP2002-158673 A (see paragraphs 0012-0022, FIG. 1, FIG. 2)

However, related arts described above pose the following problems.

Commercially available personal computers so far, in which files are only adapted to be used mutually among various types of multimedia devices connected by a network, does not seem to intend to provide unitary management of files of music, picture, video and the like. Because the examples of the patent documents 1 and 2 employ a method in which information devices individually keep a file, memory capacity of a memory device required by a whole system will increase. Although reliability of a shared file becomes higher, it may be reasonable to say that the reliability is unnecessarily high for a home network. Furthermore, because synchronization is carried out for all the files, transmission of data resulting from the synchronization will impose a high load on the network.

In addition, it will be too much cost for a small scale network such as a home network if it is equipped with a server. This is ascribed to the fact that it is necessary to keep the server in continuous operation, because the whole system sharing and managing files ceases its functions while the server is not in operation.

### SUMMARY OF THE INVENTION

One aspect of the present invention is to realize a system, which enables both mutual use of files kept by multimedia information devices connected to a home network and unitary management of the files, by introducing means which does not require high cost or high load for the network. It should be noted that illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

The present invention employs a special file called an integrated directory list. The integrated directory list contains a table showing file attributes, such as file name, size, location and the like, for all files kept by individual multimedia information devices connected to a network, in other words, a complete table of contents. In addition, the present invention defines separate roles for a master device and a slave device for multimedia information devices, respectively, thereby allowing unitary management of the integrated directory list under administration conducted by the master device.

It is an aspect of the present invention to provide a master device for multimedia information which is connected to at least one slave device for multimedia information via a network. The master device comprises: (1) means for generating a self directory list by retrieving files stored in a memory of the master device; (2) means for collecting a directory list of the slave device by at least one of retrieving files stored in a memory of the slave device and receiving the directory list generated by the slave device; (3) means for generating an integrated directory list by integrating the self directory list of the master device and the directory list collected from the slave device; and (4) means for retrieving and displaying the integrated directory list. In addition, it is possible to implement a program (program product) for managing files, which executes processors of the multimedia devices described above as means (1) to (4).

Because the master device for multimedia information described above is able to collect the directory lists of the slave devices including conventional multimedia information devices, the master device is able to generate the integrated directory list for the whole network. In this way, the master device is able not only to conduct the unitary management of files of the whole network, but also to enjoy various types of convenience, which the means for retrieving and displaying integrated directory list provides.

It may be possible that the master device has (5) means for distributing the integrated directory list to the slave device via the network. Furthermore, it is possible to implement a program (program product) for managing files, which executes processors of the multimedia devices described above as means (5) in addition to (1) to (4).

Because the master device described above is able to distribute the integrated directory list to slave devices, these slave devices are able to enjoy various types of convenience provided by the integrated directory list.

It is another aspect of the present invention to provide a slave device for multimedia information connected via a network to a master device for multimedia information and the slave device comprises: (6) means for generating a self directory list by retrieving files stored in a memory of the slave device; and (7) means for distributing the self directory list to the master device via the network. In addition, it is possible to implement a program (program product) for managing files, which executes processors of the slave devices described above as means (6) and (7).

The slave devices described above are able to immediately distribute the self directory list to the master device in response to a request for distribution made by the master device.

It may be possible that the slave device has (8) means for retrieving and displaying the integrated directory list which is distributed via the network by the master device for multimedia information. Furthermore, it is possible to implement a program (program product) for managing files, which executes processors of the slave devices described above as means (8) in addition to (6) and (7).

The slave devices described above are able to enjoy various types of convenience provided by the integrated directory list.

It may be possible that in a device for multimedia information and a computer program for managing files, conditions established for retrieving an integrated directory list are defined by data which is entered via an input slot displayed on means for retrieving and displaying. Because a user is able to freely input the conditions with the device described above, it is possible to increase convenience for utilization of the integrated directory list.

It may be possible that in a device for multimedia information and a computer program for managing files, conditions established for retrieving an integrated directory list are defined by data which is memorized beforehand in a memory of means for retrieving and displaying. In the device and the computer program configured above, it is possible to display an integrated directory list containing results of retrieval according to the conditions stored in a memory device, which are selected beforehand by a user or unique to a device, without entering conditions for retrieval at each time of retrieval. For example, it may be possible for an MP3 player to only display files recorded in MP3 format without entering conditions for retrieval. In this way, it may be possible to increase convenience of the integrated directory list.

It is still another aspect of the present invention to provide a network system in which one or a plurality of slave devices and one master device for multimedia information are connected by a network, [1] the master device comprising: (1) means for generating a self directory list by retrieving files stored in a memory of the master device; (2) means for collecting a directory list of the slave device by at least one of retrieving a file stored in a memory of the slave device and receiving the directory list generated by the slave device; (3) means for generating an integrated directory list by integrating the self directory list of the master device and the directory list collected from the slave device; (4) means for distributing the integrated directory list to the slave device via the network; and (5) means for retrieving and displaying the integrated directory list, [2] the slave device comprising: (6) means for generating a self directory list by retrieving files stored in a memory of the slave device; (7) means for distributing the self directory list to the master device via the network; and (8) means for retrieving and displaying the integrated directory list which is distributed via the network by the master device for multimedia information, [3] wherein at least one of the slave devices and the master device each possess (9) the integrated directory list in a synchronized form.

Because the master device and at least one slave device each possess an integrated directory list in the synchronized form, it is possible to freely retrieve and display every file within the network, which enables unitary management of available files.

It is yet another aspect of the present invention to provide a method for managing a file in a network system, which comprises the steps of: (a) when a change occurs in the directory list of the master device, the master device updating the integrated directory list based on the change; (b) when a change occurs in the directory list of one slave device, the slave device notifying the master device of the change, and the master device collecting the directory list of the slave device and updating the integrated directory list based on the collected directory list; and (c) distributing the updated integrated directory list to at least one of the slave devices.

The method described above makes it possible for the master device to conduct correct synchronization of the integrated directory list with the slave device.

It may be possible that in addition to the steps (a) to (c) a method comprises the steps of: (d) when a new device for multimedia information is connected to the network system, the new device notifying the master device of new connection; (e) the master device collecting a directory list of the new device based on notification provided by the new device and comparing scores of master adaptability written on directory lists of the master device and the new device; (f) when the score of the new device is higher than the score of the master device, the master device notifying the new device of replacement of a master and distributing the integrated directory list which the master device possesses to the new device, consequently the new device starting to act as a master device; and (g) when the score of the new device is not higher than the score of the master device, the new device starting to act as a slave device.

According to the method described above, a device having higher score of master adaptability is always selected as a master device within the network system. This will lead to an increase in performance in terms of managing files for the whole network system.

It may be possible that in addition to the steps (a) to (c) or the steps (a) to (g) a method comprises the steps of: (h) when the master device withdraws from the network, the master device extracting a device which has a highest score of master adaptability second to the master device, notifying the extracted device of replacement of a master, and distributing an updated integrated directory list from which the directory list of the master device is removed to the extracted device; and (i) the device, which has received the updated integrated directory list, starting to act as a master device.

Because the device having the highest score of master adaptability second to the current master device, it will not happen that the position of a master device is not filled even if the master device is separated from the network system. Therefore, discontinuation of generating an integrated directory list does not occur, which keeps unitary management of files continuing.

It may be possible that in addition to the steps (a) to (c), the steps (a) to (g) or the steps (a) to (i) a method comprises the steps of: (j) selecting a file to be used with a cursor out of names of files displayed by the means for retrieving and displaying the integrated directory list; (k) retrieving the integrated directory list and checking if there is a file equivalent with the selected file; (1) when there is the equivalent file, comparing data transmission speeds of devices for multimedia information which store files; (m) when a data transmission speed of a device which stores the equivalent file is higher than a data transmission speed of a device which stores the selected file, replacing the selected file with the equivalent file.

Because the file stored in the device having the higher data transmission speed is selected for use instead of the file stored in the device having the lower data transmission, which a user has appointed, it may be possible to increase performance of the whole system due to a reduction in a load imposed on the network.

It may be possible that in addition to the steps (a) to (c), the steps (a) to (g), the steps (a) to (i) or the steps (a) to (m) a method comprises the steps of: (n) after the master device distributes the integrated directory list to the slave device, the master device retracting a file newly registered, a file newly used and a file which has been used not less than certain number of times while retrieving the integrated directory list; and (O) when the extracted file lies in a device for multimedia information having a lower data transmission speed and a device for multimedia information having a higher data transmission speed keeps a vacancy not less than a certain memory capacity, transferring the extracted file residing in the device having the lower data transmission speed to the device having the higher data transmission speed.

The greater frequency of use a file has, in a device having the higher data transmission speed it is stored. In this way, the method will contribute to a reduction in a load imposed on the network in subsequent stages and an increase in performance of the system.

It may be possible that in addition to the steps (a) to (c), the steps (a) to (g), the steps (a) to (i), the steps (a) to (m) or the steps (a) to (o) a method comprises the steps of: (p) after the master device distributes the integrated directory list to the slave device, the master device extracting a file which lies in a mobile device for multimedia information and which has not been evacuated to a fixed device for multimedia information driven by an AC power supply while retrieving the integrated directory list; and (q) transferring the extracted file to the fixed device.

The method described above allows the file in the mobile device for multimedia information to be timely transferred to the fixed device driven by the AC power supply. In this way, multimedia information devices connected to the network are able to use the file, which has been transferred to the fixed device, even if the mobile device is separated from the network.

The present invention described above brings about the following advantages.

Because the present invention generates the integrated directory list which integrates files possessed by the individual multimedia information devices forming the network system and manages the integrated directory list, it is possible to conduct unitary management of these files with the integrated directory list.

Because the present invention employs the integrated directory file, which is the sole file shared by multimedia information devices, it is possible to remarkably reduce capacity of a memory device, which leads to a remarkable reduction in cost of the memory device as the whole system. Furthermore, it is possible to implement a remarkable reduction not only in an amount of file transmission required for synchronization but also in a load imposed on the network. This is due to the fact that the present invention limits files requiring synchronization to those related to the integrated directory file.

Because a device is able to take over a master device of multimedia information if the master device is separated from a network, it is possible to provide unitary management of files of the whole system without a server, which leads to a reduction in cost for the whole system.

In addition, it is possible to increase not only performance of the system but also convenience of a user by introducing means for retrieving and displaying integrated directory list and means for relocating file.

The aspects and advantages described above and other advantages and features of the present invention will become more apparent by describing in detail illustrative, non-limiting embodiments thereof with reference to the accompanying drawings.

### BRIEF DESCRIPTION OF THE DRAWINGS

FIG. 1 is a schematic diagram illustrating an example of home network to which the present invention is applied.

FIG. 2 is a schematic diagram illustrating structure of a file for an integrated directory list according to an embodiment of the present invention.

FIG. 3 is a block diagram showing structure of a multimedia information device according to an embodiment of the present invention.

FIG. 4 is a schematic diagram illustrating an example of display when an integrated directory list is retrieved according to an embodiment of the present invention.

FIG. 5 is a schematic diagram illustrating an example of display when prioritized retrieval and display of an integrated directory list is conducted according to an embodiment of the present invention.

FIG. 6 is a flow chart showing steps conducted by master and slave devices, when an integrated directory list is updated and synchronized, according to an embodiment of the present invention.

FIG. 7 is a flow chart showing steps conducted by a master device, a new device and a slave device, when the new device is connected to a network system in operation and the new device takes over the master device, according to an embodiment of the present invention.

FIG. 8 is a flow chart showing steps conducted by master and slave devices for replacement of a master, when the master device in operation withdraws from a network, according to an embodiment of the present invention.

FIG. 9 is a flow chart showing steps conducted by master and slave devices, when the slave device in operation withdraws from a network, according to an embodiment of the present invention.

FIG. 10 is a flow chart showing steps when a device is turned on and connected to a network according to an embodiment of the present invention.

FIG. 11 is a schematic diagram illustrating an example of display showing a screen for retrieval and displaying, when a computer program for optimum selection is conducted, according to an embodiment of the present invention.

FIG. 12 is a flow chart showing steps conducted by a computer program for optimal relocation of files according to an embodiment of the present invention.

### DESCRIPTION OF THE PREFERRED EMBODIMENTS

Description is now given of embodiments of the present invention with reference to drawings.

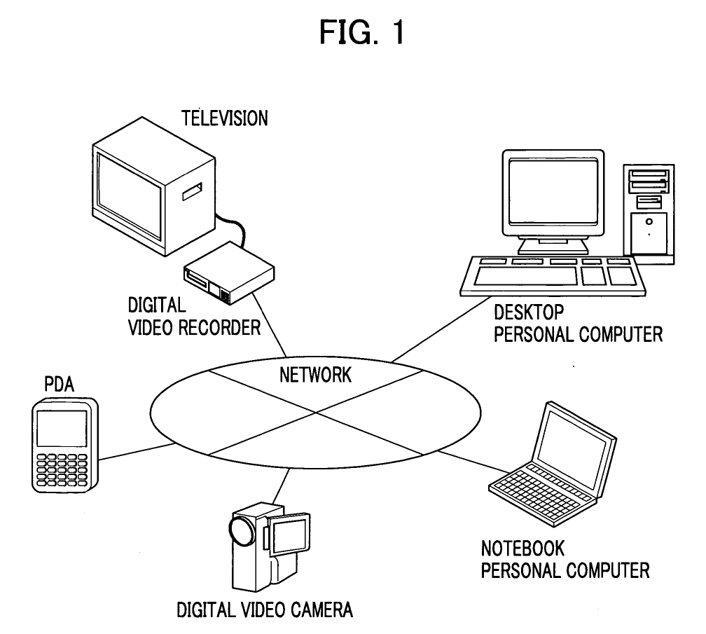

FIG. 1 shows an example of home network to which the present invention is applied. The network is established in conformity with, for example, IEEE802.3 or IEEE1394 standard, to which a desktop personal computer, a notebook personal computer, a PDA, a digital video recorder for recording TV broadcasting, a digital video camera and the like are connected. In addition, it may be possible to connect a panel personal computer of a refrigerator or a digital camera to the network.

In the network system for multimedia information devices described above, a user is able to display a list of files recorded in MPEG2 format, for example, on a display of a personal computer which he uses. Selecting a TV drama (a file in MPEG2 format) recorded in a digital video recorder from the displayed list, the user is able to see the image on his personal computer.

In order to implement functions described above with low cost and without imposing a load on the network, this embodiment employs a special file called an integrated directory list which is possessed by multimedia information devices connected to the network. As described above, an integrated directory list is a list showing file attributes such as file name, size, location and the like for all files possessed by the multimedia information devices connected to the network, compared to a complete table of contents for the files.

Selecting a device, which is close to a server computer as much as possible, from the multimedia information devices connected to the network, this embodiment assigns the selected device to a master device for multimedia information and the others to slave devices. In an example shown in FIG. 1, it may be reasonable to assign a desktop computer to a master device for multimedia information. In this way, this multimedia information device is assigned to generation of an integrated directory list, its updating and its distribution to the slave devices.

In this embodiment, the master and slave devices for multimedia information individually possess the integrated directory list and synchronize it, which enables unitary management of files in the whole network system for the multimedia information devices and use of the files by the individual devices.

In descriptions and drawings hereinafter, “multimedia information device” is referred to as “device”. Similarly, “master device for multimedia information” is referred to as “master device” or “master” simply. Also, “slave device for multimedia information” is referred to as “slave device” or “slave” simply.

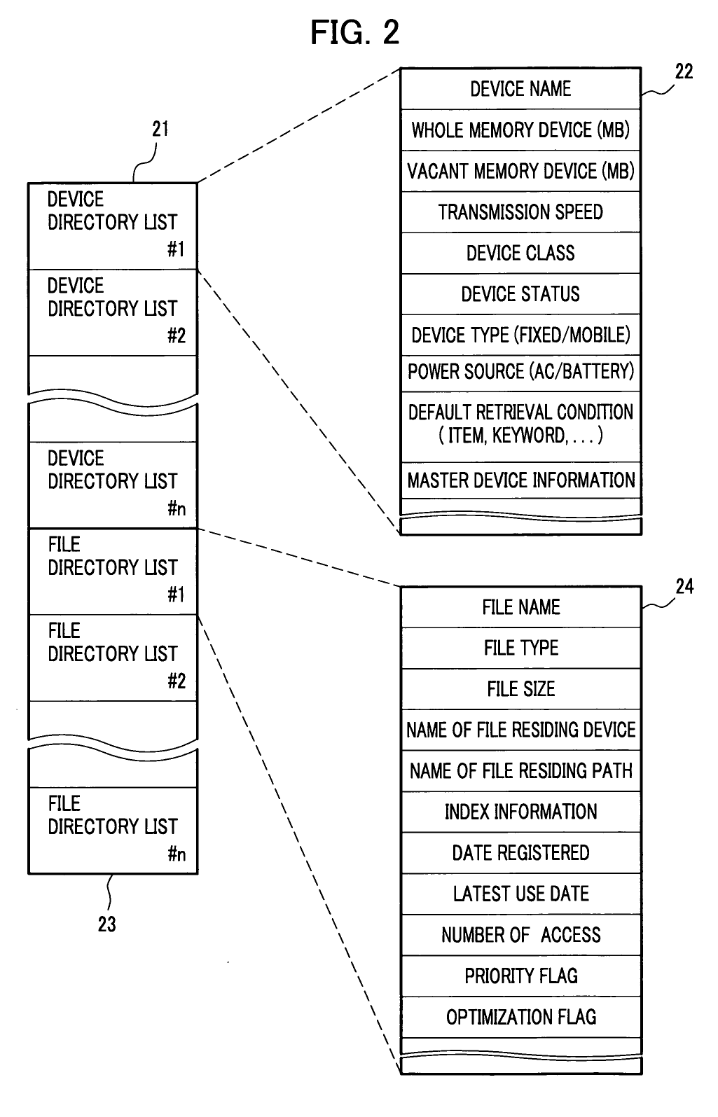

FIG. 2 is a schematic diagram illustrating structure of files for an integrated directory list. As shown in FIG. 2, the integrated directory list includes a device directory list 21 and a file directory list 23.

The device directory list 21 describes attributes of each of devices, which are connected to the network. Numeral 22 represents an example of structure for a unit of device directory list in the form of field. In the unit 22 of device directory list, fields are arranged, such as device name, total memory capacity possessed by a device, vacant memory capacity, transmission speed (readout and write-in speed), device class, device status, device type (fixed/mobile), type of power source (AC/battery), default retrieval conditions, master device information and the like.

A device class represents adaptability of a multimedia information device to a network system, namely adaptability to being qualified as a master device. Description in detail is given of this device class. A device status represents a status of a device, including such as being in operation, being in no operation (no media inserted into a digital video camera, for example) and prohibition of writing-in.

Similarly, in a unit 24 of file directory list, fields are arranged, such as file name, file type, file size, name of residing device, name of residing path, index information, date of file registered, date of latest use, number of times used, priority flag, optimization flag and the like.

A file type represents a symbol showing a recording format of file or a symbol specifying a program which is started up by the file. Index information, which provides a user with a free field in which he can writes supplementary information of a file, may be a title of a movie, a name of a producer or a name of a composer. A priority flag is a flag indicating that a file having this flag is prioritized to display. An optimization flag is a flag indicating that a file with this flag has been once transferred to a device, which is judged to be optimal for the file.

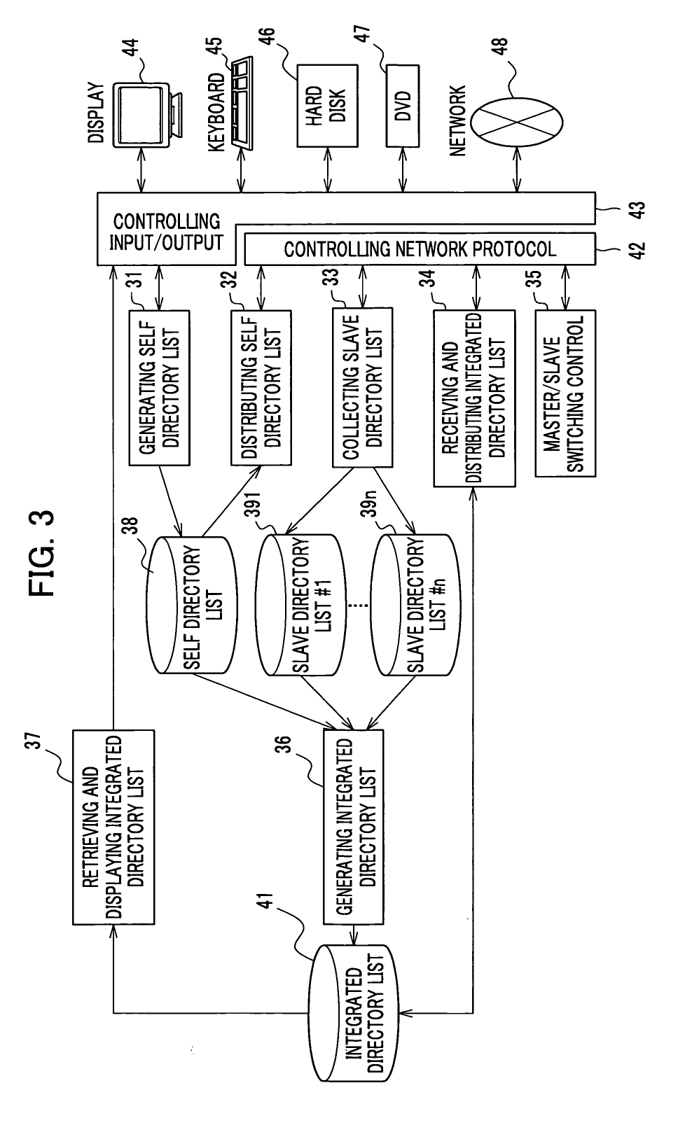

FIG. 3 is a block diagram showing structure of a multimedia information device according to this embodiment. In this structure, the multimedia information device can be selectively assigned to a master device or a slave device. The structure similar to that of a personal computer has a CPU and a memory, not shown on the diagram, to which a display 44, a keyboard 45, a hard disk 46 for storing files, a DVD 47 and a network 48 are connected as peripheral devices.

Application programs related to processing of directory list, which is loaded onto a memory (not shown) and executed by the CPU, includes a program 31 for generating self directory list, a program 32 for distributing self directory list, a program 33 for collecting slave directory list, a program 36 for generating integrated directory list, a program 34 for receiving and distributing integrated directory list, a program 37 for retrieving and displaying integrated directory list, a program 35 for master/slave switching control and other programs not shown on the diagram. Furthermore, a program 42 for controlling network protocol and a program 43 for controlling input/output are included as a part of OS (Operating System).

Brief description is given of functions and contents of processing for each of the application programs related to processing of directory list.

The program 31 for generating self directory list searches files, which is stored in memory devices (the hard disk 46 and the DVD 47 in case of FIG. 3) connected to the multimedia information device, for files which are appropriate for being shared in a system. The program 31 generates a disk directory for each of the extracted files, which is stored in the hard disk 46 as a file 38 for self directory list. In case of a home network, files appropriate for being shared in a system typically include multimedia data, such as music data, steel photo data and animation data. It may also be possible that the file is text data which contains the data described above. In this connection, extraction of this multimedia data is conducted by distinguishing an extension and a recording format of a file.

Once a file 38 for self directory list is generated by the program 31, it is only necessary to update the file 38 when the files appropriate for being shared in the system are changed or deleted.

After the program 31 generates or updates the file 38 for self directory list, the program 31 starts up the program 36 for generating integrated directory list, and comes to termination, when a device is a master device. When a device is a slave device instead, the program 31 starts up the program 32 for distributing self directory list, coming to termination.

The program 32 works when a device is a slave device. The program 32, which is started up when the program 31 generates or updates a file 38 for self directory list, not only notifies a master device of the change but also distributes the file 38 to the master device. In this connection, it may be possible to adopt a differential file for the file 38.

The program 33 for collecting slave directory list, which collects directory lists of slave devices, works only when a device is a master device. As there are two methods for collecting directory lists of slave devices, the program 33 is composed of two portions.

One is a program which is executed when a slave device possesses both a program 31 for generating self directory list and a program 32 for distributing self directory list. When a self directory list is generated or updated in the slave device, the slave device notifies the generation or updating. The program 33 for collecting slave directory list is started up triggered by the notification, receiving the self directory list of the slave. Subsequently, the program 33 generates slave directory lists #1-#n in file 391-39n (see FIG. 2) based on the self directory list, starting up the program 36 for generating integrated directory list. In this connection, it may be possible to distribute a differential file when distribution is conducted for change in the self directory list.

The other one is a program which is executed when a slave device does not possess either a program 31 for generating self directory list or a program 32 for distributing self directory list. Because the slave device does not notify the master device of generation or updating of self directory list, the program 33 for collecting slave directory list is started up at certain intervals. The program 33 checks generation or change of a file by accessing to a memory device of the slave device each time the program 33 is started up. When there is generation or change of the file, the program 33 generates or changes slave directory lists #1-#n in file 391-39n (see FIG. 2) based on information obtained from the file, to which the program 33 has accessed, starting up the program 36 for generating integrated directory list.

The program 36 for generating integrated directory list, which is only started up when a device is a master device, is started up by the program 31 for generating self directory list or the program 33 for collecting slave directory list. The program 36 generates or changes an integrated directory list 41 based on the file 38 for self directory list or slave directory lists #1-#n in file 391-39n (see FIG. 2), which have been generated or changed by the programs 31 and 33. The program 36 starts up the program 37 for retrieving and displaying integrated directory list.

The program 34 for receiving and distributing integrated directory list executes different processing depending on whether a device is a master or slave device. When the device is a master device, the program 34 notifies slave devices of distribution of an integrated directory list 41, which the program 36 for generating integrated directory list has generated or changed, conducting distribution of the list 41. When the device is a slave device, the program 34 generates or changes an integrated directory list 41 based on a list 41, which the program 34 receives from a master device after notification of its distribution. In this connection, it may be alternatively possible to adopt a differential file for distribution of the integrated directory list 41.

The program 37 for retrieving and displaying integrated directory list displays contents of an integrated directory list 41. The program for master/slave switching is executed when a device is assigned to a master, or a slave device is switched to be a master device. Description is given of these programs below, separately.

The block diagram shown in FIG. 3 depicts structure of a device which can be assigned versatilely to one of a master device and a slave device. If the device is assigned only to a slave device, it may be unnecessary to have application programs 31 to 37 shown in FIG. 3. A slave device is only required to possess means which allows other devices to access to a memory device in this slave device.

However, if it is desired that a slave device should provide convenience resulting from use of files by introduction of displaying of an integrated directory list and retrieval of necessary files, the slave device is required to possess a program 34 for receiving and distributing integrated directory list, a program 37 for retrieving and displaying integrated directory list and an integrated directory list 41 at the minimum. If a slave device possesses a program 31 for generating self directory list, a program 32 for distributing self directory list and a file 38 for self directory list, it may be possible to increase efficiency of collecting slave directory lists by a master device, which leads to an increase in performance of the whole system.

It is not mandatory to adopt a hard disk 46 and a DVD 47 as memory devices as shown in FIG. 3. It may be alternatively possible to use a memory device, which is readable and writable or only readable. For example, it may be possible to adopt a memory device made of a flash memory or a CD-ROM. On the other hand, a display device (corresponding to a display 44) and input device (corresponding to a keyboard 45 including a pointing device), it is necessary for a master device to possess some counterparts. In contrast, it is not necessary for a slave device to possess them as long as convenience resulting from retrieving and displaying of an integrated directory list is not desired.

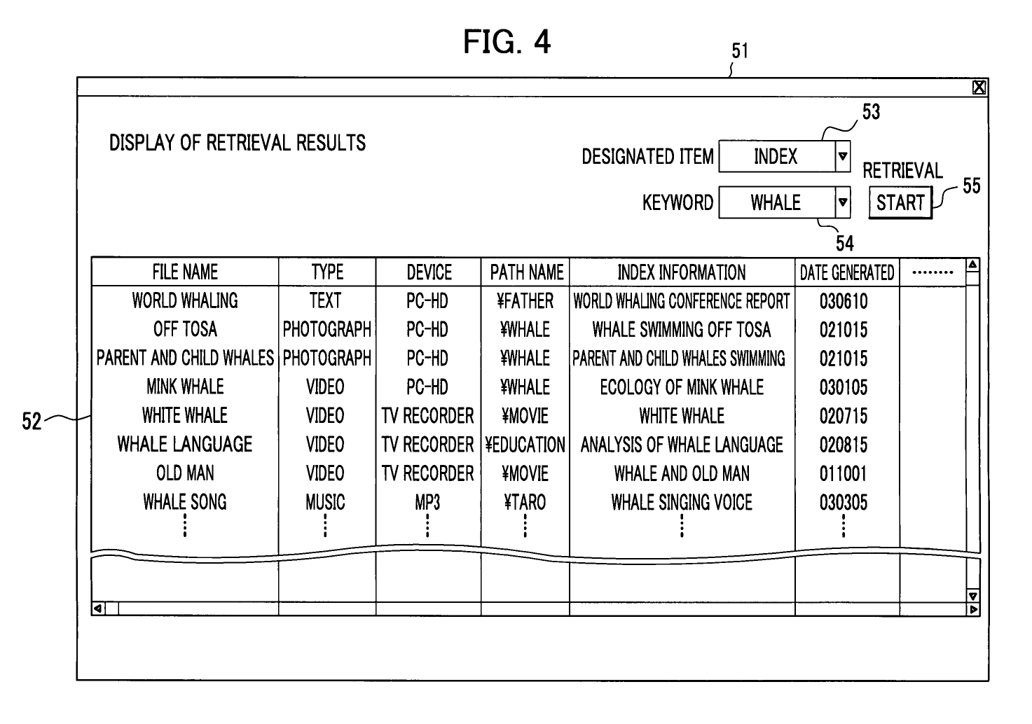

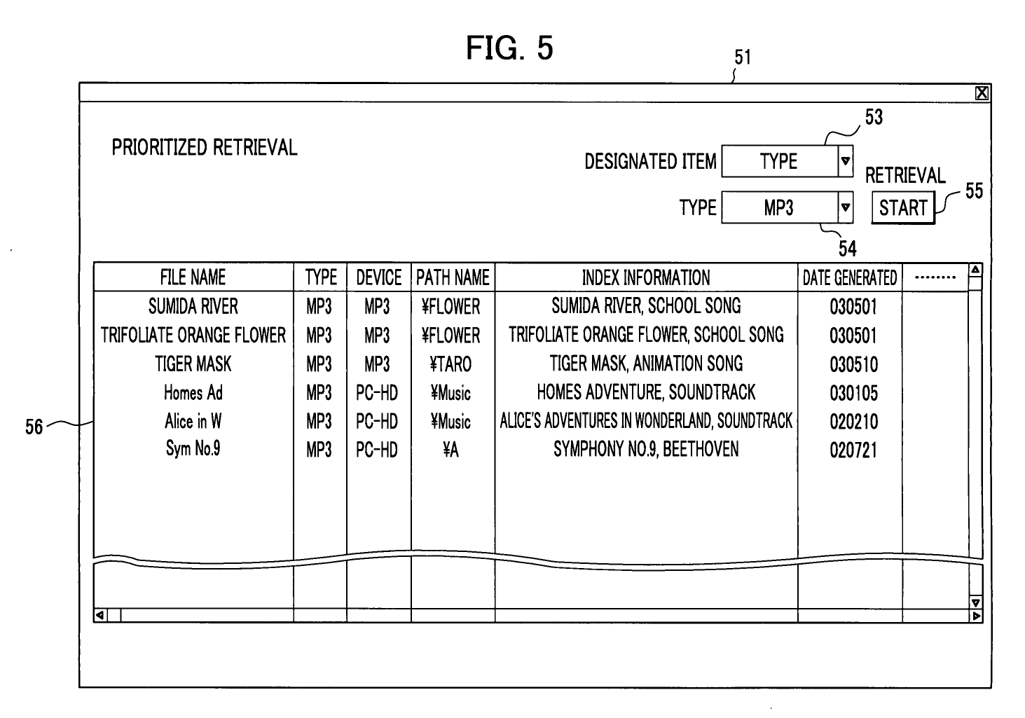

It is possible for the master and slave devices as described above not only to individually possess an integrated directory list, but also to synchronize it. In addition, users are able to enjoy many benefits from retrieving and displaying functions of an integrated directory list to be described below, which are provided by the program 37 for retrieving and displaying integrated directory list. FIG. 4 and FIG. 5 are schematic diagrams illustrating examples of retrieving and displaying functions provided by an integrated directory list.

FIG. 4 is a schematic diagram illustrating an example of displaying of results, which are obtained by retrieving an integrated directory list. As shown in FIG. 4, numeral 51 represents a window, where conditions for retrieval are entered, the retrieval is carried out and results are displayed. First, conditions for retrieval are determined for starting retrieval of an integrated directory list. For example, input to an input box 53 is carried out to designate an item to be retrieved and input of a keyword to an input box 54. In an example shown in FIG. 4, retrieval is carried out so as to extract items including “whale” as a keyword by searching a field of index information. When a button 55 for starting retrieval is pressed, retrieval of an integrated directory list is executed and results of this retrieval are displayed on the window 52.

With the displayed results as described above, a user is able to know immediately in which location of a device within a network requested files related to “whale” are found. For example, a file named “off the coast of Tosa” is a photograph showing a whale swimming off the coast of Tosa, which is stored in a folder named ¥whale in a hard disk of a personal computer. Furthermore, the user is able to handle this file. For example, if he selects a line on which a file name of white whale lies and clicks it on a device (a notebook personal computer, for example), he is able to see a movie on this device, which is recorded in a TV recorder as the file name of white whale.

FIG. 5 is a schematic diagram illustrating an example of conducting prioritized retrieving and displaying for an integrated directory list.

Prioritized retrieving and displaying is meant to represent a function executed by a program 37 for retrieving and displaying integrated directory list (see FIG. 3) so as to provide displaying in a device when default retrieving condition is selected. This condition is written in a field for default retrieving condition on a device directory list 22 (see FIG. 2) of a device. If default retrieving condition, “file type (recording format) is MP3” is written in a field on a device directory list of an MP3 player, the MP3 player carries out prioritized retrieval and displaying for an integrated directory list, thereby providing a screen shown in FIG. 5.

The program 37 for retrieving and displaying integrated directory list (see FIG. 3), which retrieves an integrated directory file 41 when the program 37 is started up by the program 36 for generating integrated directory list, obeys the default retrieving condition. Referring to a field for default retrieving condition of a directory list 22 of a device, the program 37 retrieves and displays an integrated directory list according to data in the field. In this way, prioritized retrieving and displaying is conducted in a normal flow of processing.

This prioritized retrieving and displaying function is very beneficial for a device such as an MP3 player, whose function is specialized for a particular use, and a situation where a file type used by a user inclines toward a certain category. In this connection, a MP3 player has only a function to playback a file recorded in MP3 format. If a file of video movie is displayed on the MP3 player, it is no use, and it does more harm than good. Setting conditions for retrieval described in the above example allows extraction and displaying of files recorded in only MP3 format on an MP3 player. In this way, a user is able to know immediately in which folder of a device in a network a file recorded in MP3 format is found. It goes without saying that it is possible to retrieve and display an integrated directory list shown in FIG. 4 using the boxes 53 and 54 for retrieving conditions, in addition to the displaying by the prioritized retrieving and display function described above.

Though the prioritized retrieving and displaying function is beneficial for a user as described above, it is possible for a device such as a personal computer to set conditions for retrieving and displaying in more various manners. For example, it may be possible to specifying attributes of a file, such as a file registered after **year**month**day, a file used after **year**month**day, a file frequently used after **year**month**day, a file unavailable now, a file of optimal relocation and the like.

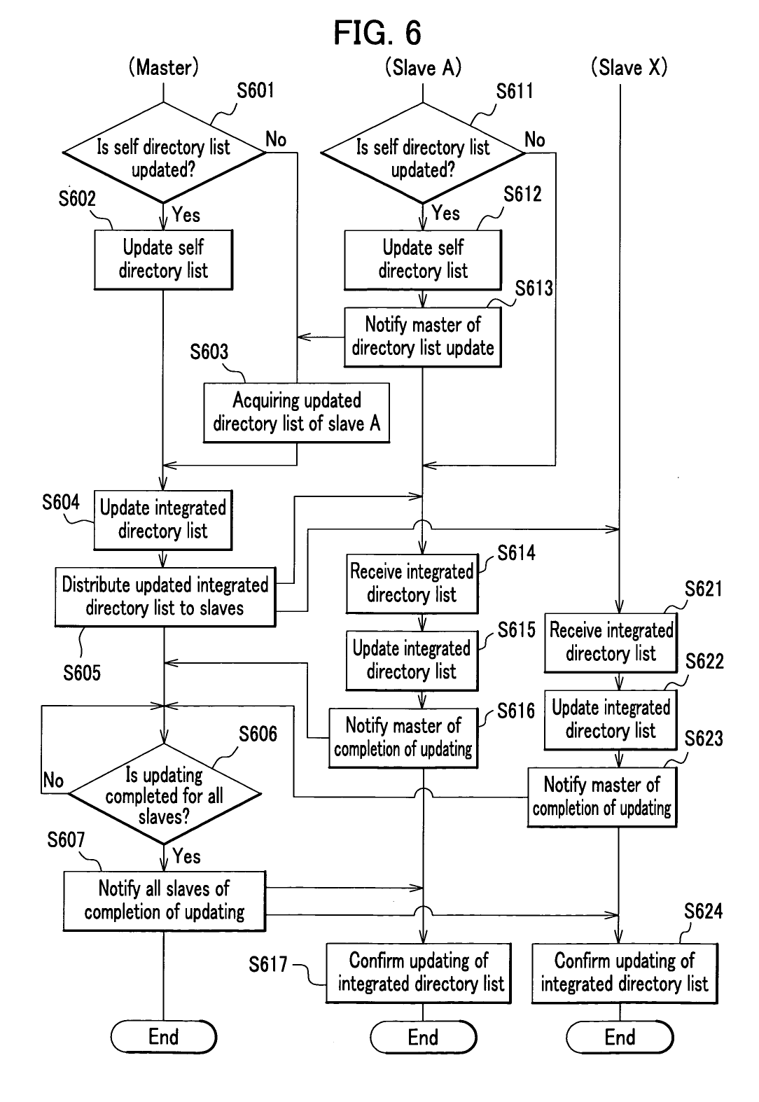

Description is now given of a flow of processing to be carried out for unitary management of integrated directory lists in master and slave devices connected to a network according to this embodiment, with reference to FIG. 6 to FIG. 10.

FIG. 6 is a flow chart showing a flow of steps carried out between master and slave devices when integrated directory lists are updated and synchronized. It is assumed that a master device possesses all application programs 31 to 37 related to processing of directory lists, and a slave A and a slave X each possess a program 31 for generating self directory list, a program 32 for distributing self directory list, a program 34 for receiving and distributing self directory list and a program 37 for retrieving and displaying integrated directory list at the minimum.

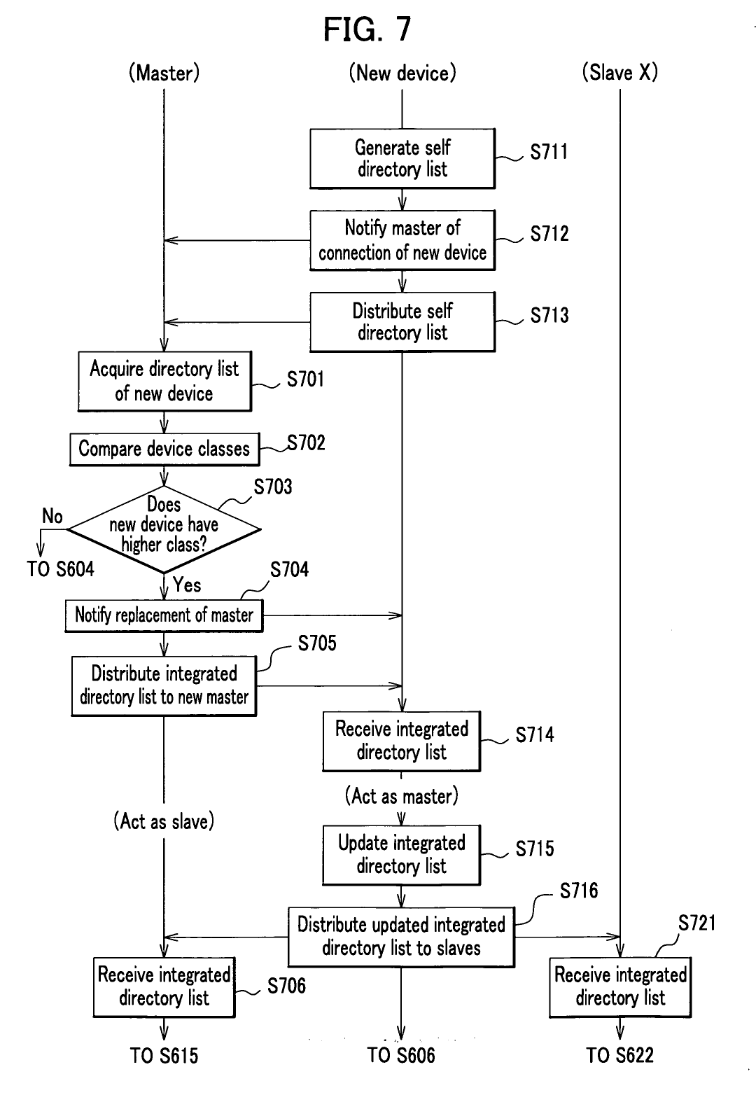

Processing of change for an integrated directory list is carried out when there is a change in a directory list of a master or slave device. In FIG. 6 a master represents a master device, a slave A represents a slave device which has a change in its directory list, and a slave X represents a slave device which does not have a change in its directory list. The features of the master, slave A and slave X described above are the same in description of FIG. 7 to FIG. 9.

When there is a change in a directory list of a master (Yes in S601), the master updates its self directory list (S602), based on which the master updates an integrated directory list (S604). Next, the master notifies the slaves A and X of updating of the integrated directory list, distributing the integrated directory list updated (S605). The slave A, which proceeds along a path with “No” in step S611, and the slave X each receive an integrated directory list (S614 and S621), which is distributed by the master. The slaves A and X update their own integrated directory lists (S615 and S622) and notify the master of completion of updating (S616 and S623). The master confirms that all the integrated directory lists have been updated (Yes in step S606) based upon whether or not the master has received notification from all the slaves. The master notifies all the slaves of completion of updating of the integrated directory lists (S607). The slaves A and X each know that updating of the integrated directory lists has been completed within the whole system (S617 and S624). This means that the integrated directory lists have been synchronized among all devices connected to the network.

When there is a change in a directory list of the slave A (Yes in S611), the slave A first updates its self directory list (S612), notifying the master of updating of this directory list (S613). The master (because there is no change in a self directory list of the master in this case, the flow follows the path designated with “No” in the step S601) acquires the updated directory list of the slave A, which is distributed by the slave A, in response to the notification made by the slave A (S603). The master updates its integrated directory list according to the directory list acquired from the slave A (S604). Processing subsequent to this step conducted by the master and the slaves A and X in the step S605 and afterward is the same as that carried out when there is a change in the directory list of the master.

FIG. 7 is a flow chart showing the relationship of steps conducted by a master device, new device and slave device, when the new device is connected to a network system in operation and the new device takes over the master device. Description is first given of a device class prior to the flow of this processing, which is described below.

The device class is defined in the directory list 22 shown in FIG. 2 for devices residing in a network system according to this embodiment. The device class is meant to represent adaptability with respect to the network system. The higher a device is adaptable to the network system, the higher it is adaptable to serving as a master device.

The following table shows an example of device class for multimedia devices on a class of 1 to 5.

Table of Device Class

| Class | Category | Example of Device |
|---|---|---|
| 5 | server | server personal computer |
| 4 | personal computer | desktop personal computer |
| | | notebook personal computer |
| 3 | network player | digital video recorder |
| | | network hard disk |
| 2 | mobile device | PDA, portable DVC, |
| | | digital camera, portable MP3 |
| | | player |
| 1 | passive drive | conventional digital camera |
| | | conventional MP3 player |

A server composed of a personal computer is classified as the highest class 5. A server has high performance in terms of processing as a computer and a hard disk with large memory capacity, and is continuously energized. A server, which may be costly, is most adaptable to a master device.

An ordinary personal computer is classified as the next class 4. The personal computer, which is less competent in terms of performance than a server and is normally energized shorter than a server, has no remarkable difficulty in being adapted to a master device.

A digital video recorder and a shared hard disk for a network, which are classified as class 3, usually possess neither an input device or display device. For this reason, they are ranked lower than an ordinary personal computer in terms of adaptability as a master. It should be noted that they will get adaptable to a master if they are provided with an input device and a display device.

A mobile device rated as class 2, whose period of time to be connected with a network is short, has lower adaptability as a master device.

A device rated as class 1 has none of the application programs 31-37 related to directory processing shown in FIG. 3 in a network system according to this embodiment. This means that this device is not entitled to serve as a master, but is passive as a slave. Accordingly, this device is only regarded as a read-and-write memory device or a read-only memory device by a master device. Since a device is connected to a network system irrespective of being passive, it is assumed that the device possesses means for network connection (an interface circuit for a network and a firmware for network protocol).

In FIG. 7, a device newly connected to a network first generates its self directory list (S711) and notifies a master of its connection to the network (S712), distributing the directory list to the master (S713). The master receives the notification and acquires the distributed directory list of the device, which has been newly connected to the network (S701). The master reads out a device class from the directory list, making a comparison of this device class with a device class of the master (S702). If the device class of the device newly connected is higher than that of the current master (Yes in S703), the master notifies the newly connected device that replacement of a master is going to be carried out (S704). The master distributes its integrated directory list to the device to be assigned to a new master (S705).

The newly connected device, namely the device to be the new master, receives the distributed integrated directory list (S714), acting as master device from now on. The new master device adds its directory list to the received integrated directory list so as to perform updating (S715), distributing the updated integrated directory list to slave devices (S716). In contrast, the ex-master which now acts as a slave and the slave X having been acting as a slave each receive the distributed integrated directory list (S706 and S721). Subsequently, confirmation for completion of updating of the integrated directory list is carried out between the master and slaves, processing of which is executed in steps S615 and its subsequent steps for the slave A, S621 and its subsequent steps for the slave X, and S606 and its subsequent steps for the master, respectively.

If the device class of the newly connected device is not higher (equal to or lower) than that of the current master (No in S703), the newly connected device acts as a slave device. In this case, it can be regarded that the newly connected device corresponds to the slave A shown in FIG. 6 and its processing compares to the step of distributing the directory list of the slave A, which has been updated, to the master device. In this way, the flow proceeds to step S604 in the FIG. 6 and the master device updates the integrated directory list by adding the directory list, which is acquired in S701, of the newly connected device (S604).

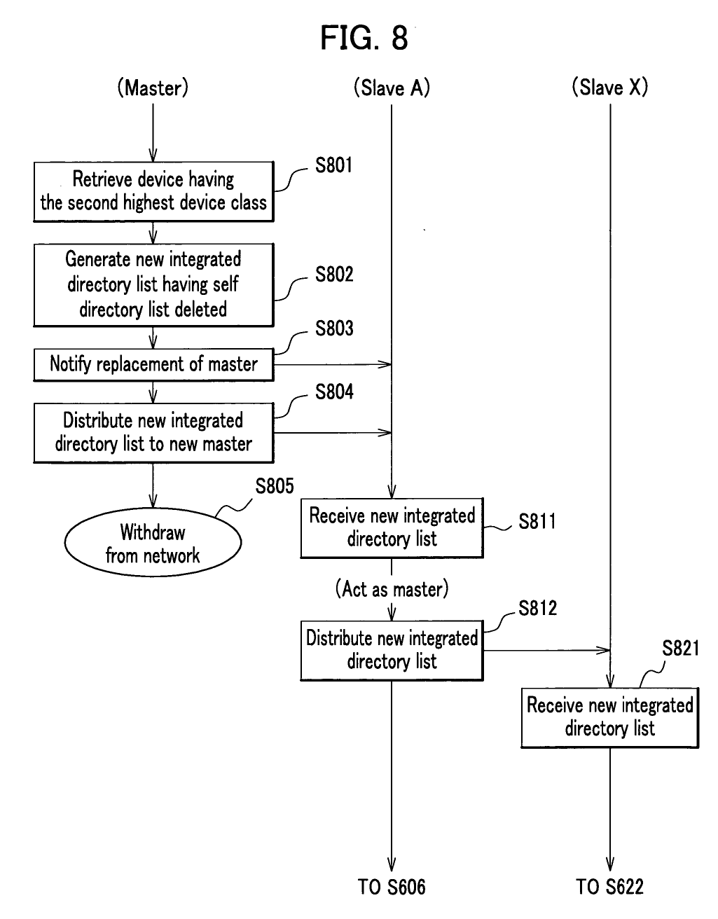

FIG. 8 is a flow chart showing the relationship of processing carried out between a master and slaves when a master device in operation withdraws from a network. When a master withdraws from a network, referring to a device directory list 21 (see FIG. 2) of an integrated directory list, the master extracts a device, which has the highest device class second to the master (S801), assigning this device to a succeeding master device. In addition, the master deletes what is included in its directory list from the integrated directory list, generating a new integrated directory list (S802). The master notifies the succeeding master, in this case the slave A, of replacement of a master (S803), and distributes the new integrated directory list to the slave A, subsequently withdrawing from the network (S805).

The slave A, which receives the new integrated directory list (S811) and acts as a master device, distributes the new integrated directory list to the slave X (S812). The slave X receives the integrated directory list distributed by the master device (S821), and subsequent processing is the same as that of S622 and its subsequent steps shown in FIG. 6. And processing of the new master is the same as that of S606 and its subsequent steps shown in FIG. 6.

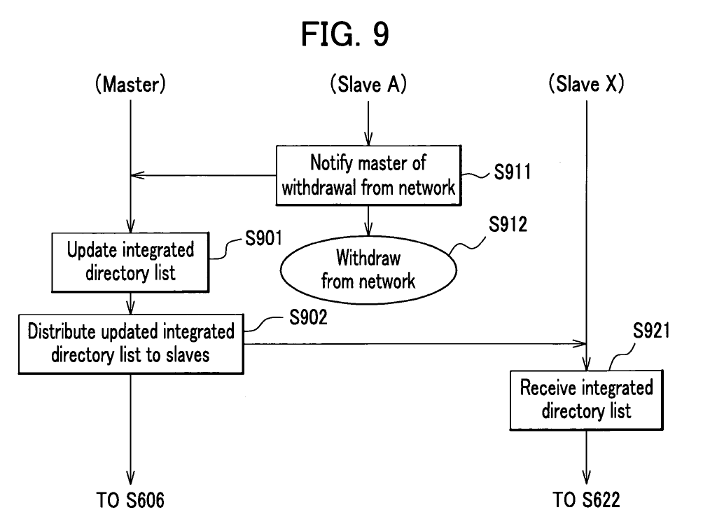

FIG. 9 is a flow chart showing the relationship of processing carried out between a master and slaves when a slave in operation withdraws from a network. A slave A to withdraw from a network notifies a master of its withdrawal (S911), withdrawing from the network afterward (S912). The master having received the notification deletes the directory list of the slave A to update an integrated directory list (S901), distributing the updated integrated directory list to the slave X (staying in the network) (S902). The slave X receives the distributed integrated directory list (S921) and the subsequent processing is the same as that of S622 and its subsequent steps shown in FIG. 6. And processing of the new master is the same as that of S606 and its subsequent steps shown in FIG. 6.

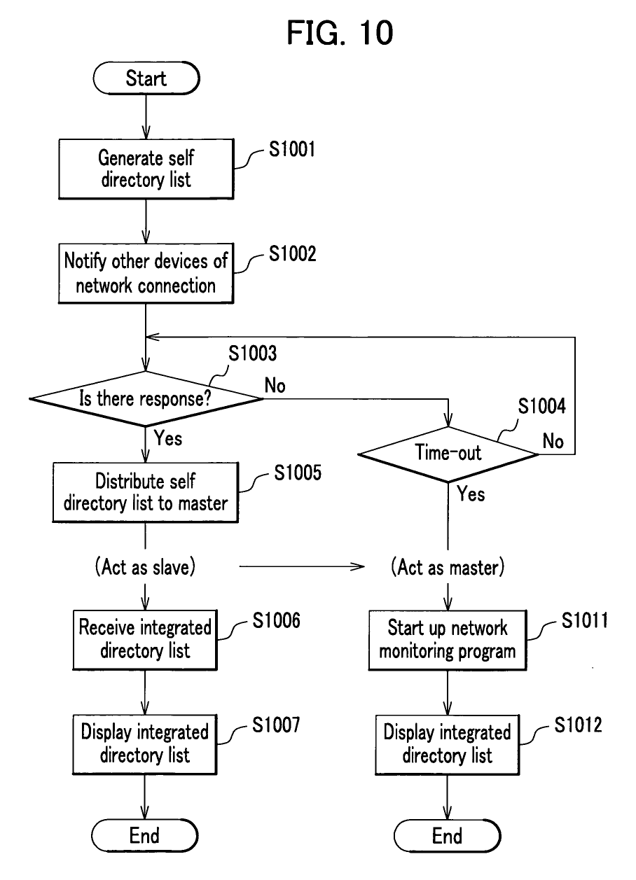

FIG. 10 is a flow chart when a device having been turned on is connected to a network. A device having been turned on and newly connected to a network first generates a self directory list (S1001), notifying other devices connected to the network of its connection to the network (S1002). If there is no response from other devices after the elapse of a certain time (No in S1003) after sending this notification, the newly connected device starts acting as a master, determining that there is no device to act as a master in the network.

On the other hand, if there is a response (Yes in S1003), the newly connected device distinguishes a master device based on the response data and distributes, acting as a slave device, its directory list to the master device. And as shown in FIG. 7, the master device makes comparison of device class (S702), determining if the master device continues to act as a master or the newly connected device takes over the master device (S703). In either case, the newly connected device may have a chance to act as a slave or a master.

When the newly connected device acts as a slave, the device receives an integrated directory list from the master (S1006) and displays it (S1007). This displaying is carried out by prioritized retrieving and displaying function as described in FIG. 5. In contrast, when the newly connected device acts as a master, the device starts up a program for monitoring a network (S1011) and generates or updates an integrated directory list, displaying this integrated directory list (S1012). This displaying is also carried out by the prioritized retrieving and displaying function as described in FIG. 5.

The program for monitoring a network shown in FIG. 7 is a program which is started up at regular intervals so as to check if a device of device class 1 is connected or disconnected from a network. Also the program directly reads out a file of the device (passive device) connected to the network so as to monitor if there is a change in the file. By introduction of this program, it is possible to manage a file possessed by a device of device class 1, using an integrated directory list.

In this embodiment, the master device possesses a program for optimal selection, which executes a function of selecting an optimal file. This function is to select and use a file residing in a device which is convenient for a user device, when there is a plurality of files, which are determined to be equivalent, in an integrated directory list. The convenient device is meant to represent a device having high speed of data transmission and low probability of withdrawing from a network.

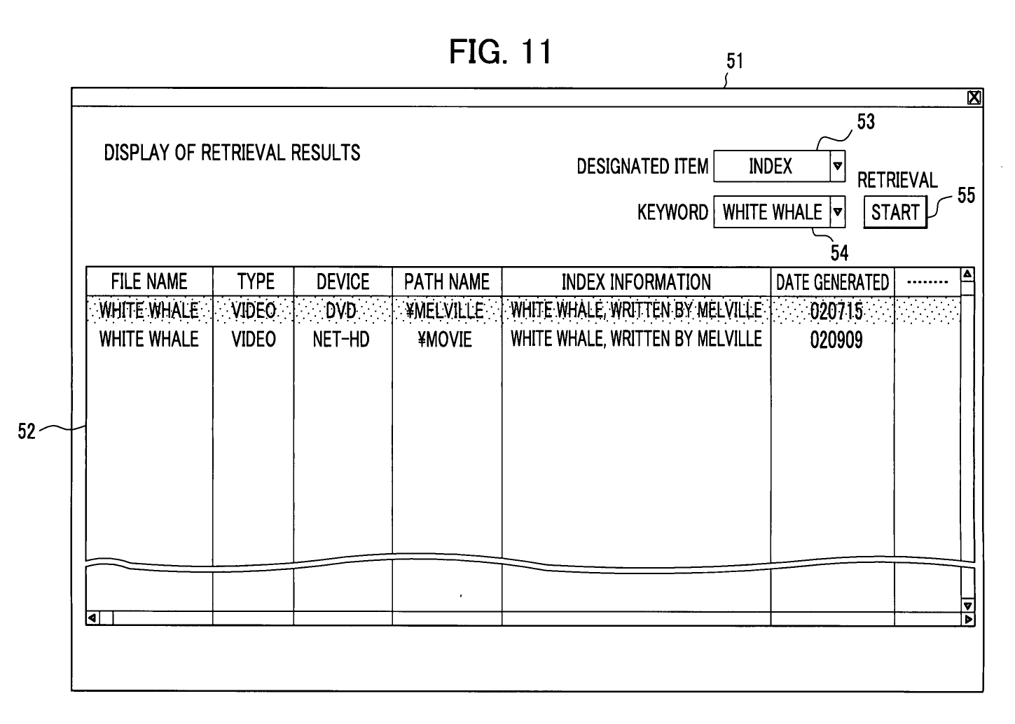

FIG. 11 is an example of retrieving and displaying screen when a program for optimal selection is executed.

As shown in FIG. 11, for example, assume that when retrieval is carried out with a keyword of white whale in the field of an index, files seemed to be equivalent have been found out in a DVD and a shared hard disk of a network. And a user clicks a file in the DVD so as to see a video. The program for optimal selection first checks if there is a file equivalent to this file in the DVD. When there is an equivalent file, the program further compares data transmission speed and characteristics of devices in which these files are stored, thereby selecting a device (in this case a shared hard disk in a network), which has higher speed of data transmission and low probability of withdrawing from the network. And the program distributes data of the file from the selected device (the shared hard disk in the network) to the device of the user.

In this connection, comparison of files in terms of equivalence is carried out by comparison of file size, data lying at the top and/or end portion of a file, or in some case whole data of a file. Also comparison of the speed of data transmission and characteristics is carried out by referring to a device directory list 22 in an integrated directory list.

In this embodiment, a master device possesses a program for optimal relocation, which executes an optimal relocation for a file. A function of optimal relocation of a file is meant to relocate a file so as to use an appropriate device as much as possible, in which the file is to be stored, when the program determines that there is a device more appropriate for storing. For example, it may contribute not only to an increase in efficiency of use but also to a decrease in a load of a network if a file having frequent access is stored in a device with high speed instead of that with low speed.

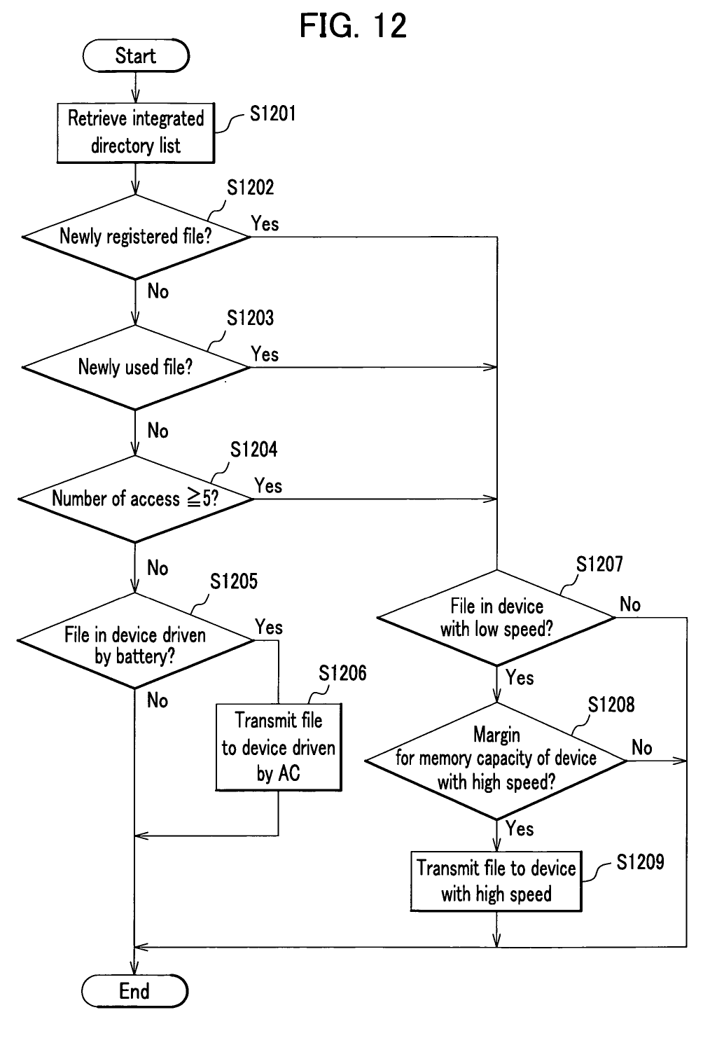

FIG. 12 is a flow chart showing processing of a program for optimal relocation. This processing of the program is executed after completion of updating and synchronization for an integrated directory list in a master as shown in FIG. 6.

The program first retrieves a file directory list 21 (see FIG. 2) of an integrated directory list (S1201) so as to check if a file is a file having been newly registered, a file having been newly used or a file having frequent access (not less than 5 times of access in this example). If the file satisfies these three conditions (Yes in S1202, S1203 and S1204, respectively), the program checks whether or not a device storing the file is a type of low speed. If the device is a type of low speed (Yes in S1207), the program retrieves a device directory list 23 (see FIG. 2) of an integrated directory list so as to check if there is a device with high speed. If there is a device with high speed, the program checks if the device with high speed has vacancy of memory capacity. If the device with the high speed has vacancy of memory capacity (Yes in S1208), the program transfers the file stored in the device with low speed to the device with high speed (S1209).

If a file falls in none of a file having newly registered, a file having newly accessed and a file having frequent access (No in each step of S1292, S1203, S1204) As a result of retrieving the file directory list 21 (see FIG. 2) of the integrated directory list (S1201), the program checks if the file is stored in a device driven by a battery. If the file is stored in a device driven by a battery (Yes in S1205), the program transfers the file to a device driven by an AC power supply (S1206). Although graphic description is omitted, it should be understood that the program checks if a memory device of the device driven by the AC power supply has an enough vacancy of memory capacity to accept the file.

Conditions and method for optimal relocation of a file is not limited to an example shown in FIG. 12.

It is contemplated that changes and modifications may be made to the exemplary embodiments of the invention without departing from the sprit and scope of the present invention as defined in the appended claims.

In the network system for multimedia information devices which is configured described above, each multimedia information device possesses an integrated directory list which administers a directory list of files kept in the device and means for continuously synchronizing this integrated directory list. Although individual multimedia information devices independently operate, the integrated directory list enables use of files in a whole system and unitary management of the files.

In the network for multimedia information devices, it is only an integrated directory list that individual multimedia information devices mutually possess. This approach allows a reduction in memory capacity of a required memory device in comparison with that in which each multimedia information device mutually possesses every copied file, which is synchronized with respect to all files possessed by other multimedia devices. This leads to a remarkable reduction in cost for the whole system. Because transmission of a file required by synchronization is limited to an integrated directory list, a load imposed on the network is also decreased remarkably.

In addition, the network system has means which makes possible a multimedia information device to take over a master. In this way, it is possible to conduct unitary management of files of the whole system without a server, which also leads to a reduction in cost for the whole system.

Furthermore, because the network system has means for retrieving and displaying integrated directory list, means for optimal use of file and means for optimal relocation of file, it is possible to increase performance of the system, which results in an increase in convenience for a user.

1. A master device for multimedia information which is connected to at least one slave device for multimedia information via a network comprising:
means for generating a self directory list by retrieving files stored in a memory of the master device;
means for collecting a directory list of the slave device by at least one of retrieving files stored in a memory of the slave device and receiving the directory list generated by the slave device;
means for generating an integrated directory list by integrating the self directory list of the master device and the directory list collected from the slave device; and
means for retrieving and displaying the integrated directory list.

2. A master device for multimedia information according to claim 1 further comprising:
means for distributing the integrated directory list to the slave device via the network.

3. A master device for multimedia information according to claim 1, wherein the slave device comprises:
means for generating a self directory list by retrieving files stored in a memory of the slave device; and
means for distributing the self directory list to the master device via the network.

4. A master device for multimedia information according to claim 2, wherein the slave device comprises:
means for generating a self directory list by retrieving files stored in a memory of the slave device; and
means for distributing the self directory list to the master device via the network.

5. A master device for multimedia information according to claim 4, wherein the slave device further comprises means for retrieving and displaying the integrated directory list which is distributed via the network by the master device for multimedia information.

6. A master device for multimedia information according to claim 1, wherein conditions established for retrieving the integrated directory list are defined by data which is entered via an input slot displayed on the means for retrieving and displaying.

7. A master device for multimedia information according to claim 1, wherein conditions established for retrieving the integrated directory list are defined by data which is memorized beforehand in a memory of the means for retrieving and displaying.

8. A computer program for managing files of a master device for multimedia information which is connected via a network to at least one slave device for multimedia information, the computer program executing a processor of the master device in a process comprising:
generating a self directory list by retrieving the files stored in a memory of the master device;
collecting a directory list of the slave device by at least one of retrieving files stored in a memory of the slave device and receiving the directory list generated by the slave device;
generating an integrated directory list by integrating the self directory list of the master device and the directory list collected from the slave device; and
retrieving and displaying the integrated directory list.

9. A computer program according to claim 8 further executing the processor in a process comprising distributing the integrated directory list to the slave device via the network.

10. (canceled)

11. (canceled)

12. A computer program according to claim 27 further executing the processor in a process comprising retrieving and displaying the integrated directory list which is distributed via the network by the master device.

13. A computer program according to claim 8, wherein conditions established for retrieving the integrated directory list are defined by data which is entered via an input slot displayed on the means for retrieving and displaying.

14. A computer program according to claim 8, wherein conditions established for retrieving the integrated directory list are defined by data which is memorized beforehand in a memory of the means for retrieving and displaying.

15. A network system in which one or a plurality of slave devices and one master device for multimedia information are connected by a network,
wherein the master device comprises:
means for generating a self directory list by retrieving files stored in a memory of the master device;
means for collecting a directory list of the slave device by at least one of retrieving files stored in a memory of the slave device and receiving the directory list generated by the slave device;
means for generating an integrated directory list by integrating the self directory list of the master device and the directory list collected from the slave device;
means for distributing the integrated directory list to the slave device via the network; and
means for retrieving and displaying the integrated directory list,
wherein the slave device comprises:
means for generating a self directory list by retrieving files stored in a memory of the slave device;
means for distributing the self directory list to the master device via the network; and
means for retrieving and displaying the integrated directory list which is distributed via the network by the master device for multimedia information,
wherein at least one of the slave devices and the master device each possess the integrated directory list in a synchronized form.

16. A method for managing a file in a network system, in which one or a plurality of slave devices and one master device for multimedia information are connected by the network,
wherein the master device comprises:
means for generating a self directory list by retrieving files stored in a memory of the master device;
means for collecting a directory list of the slave device by at least one of retrieving files stored in a memory of the slave device and receiving the directory list generated by the slave device;
means for generating an integrated directory list by integrating the self directory list of the master device and the directory list collected from the slave device;
means for distributing the integrated directory list to the slave device via the network; and
means for retrieving and displaying the integrated directory list,
wherein the slave device comprises:
means for generating a self directory list by retrieving files stored in a memory of the slave device;
means for distributing the self directory list to the master device via the network; and
means for retrieving and displaying the integrated directory list which is distributed via the network by the master device,
wherein at least one of the slave devices and the master device each possess the integrated directory list in a synchronized form,
the method comprising the steps of:
when a change occurs in the directory list of the master device, updating the integrated directory list based on the change;
when a change occurs in the directory list of one slave device, notifying the master device of the change, collecting the directory list of the slave device and updating the integrated directory list based on the collected directory list; and
distributing the updated integrated directory list to at least one of the slave devices.

17. A method according to claim 16 further comprising the steps of:
when a new device for multimedia information is connected to the network system, notifying the master device of new connection;
collecting a directory list of the new device based on notification provided by the new device, and comparing scores of master adaptability written on directory lists of the master device and the new device;
when the score of the new device is higher than the score of the master device, notifying the new device of replacement of a master, distributing the integrated directory list which the master device possesses to the new device, and starting the new device acting as a master device; and
when the score of the new device is not higher than the score of the master device, starting the new device acting as a slave device.

18. A method according to claim 16 further comprising the steps of:
when the master device withdraws from the network, extracting a device which has a highest score of master adaptability second to the master device, notifying the extracted device of replacement of a master, and distributing an updated integrated directory list, from which the directory list of the master device is removed, to the extracted device; and
starting the device, which has received the updated integrated directory list, acting as a master device.

19. A method according to claim 16 further comprising the steps of:
selecting a file to be used with a cursor out of names of files displayed by the means for retrieving and displaying the integrated directory list;
retrieving the integrated directory list and checking if there is a file equivalent to the selected file;
when there is the equivalent file, comparing data transmission speeds of devices for multimedia information which store files; and
when a data transmission speed of a device which stores the equivalent file is higher than a data transmission speed of a device which stores the selected file, replacing the selected file with the equivalent file.

20. A method according to claim 16 further comprising the steps of:
after the master device distributes the integrated directory list to the slave device, retracting a file newly registered, a file newly used and a file which has been used not less than certain number of times while retrieving the integrated directory list;
when the extracted file resides in a device for multimedia information having a lower data transmission speed and a device for multimedia information having a higher data transmission speed keeps a vacancy not less than a certain memory capacity, transferring the extracted file residing in the device having the lower data transmission speed to the device having the higher data transmission speed.

21. A method according to claim 16 further comprising the steps of:
after the master device distributes the integrated directory list to the slave device, extracting a file which resides in a mobile device for multimedia information and which has not been evacuated to a fixed device for multimedia information driven by an AC power supply while retrieving the integrated directory list; and
transferring the extracted file to the fixed device.

22. A master device for multimedia information according to claim 2, wherein conditions established for retrieving the integrated directory list are defined by data which is entered via an input slot displayed on the means for retrieving and displaying.

23. A master device for multimedia information according to claim 5, wherein conditions established for retrieving the integrated directory list are defined by data which is entered via an input slot displayed on the means for retrieving and displaying.

24. A master device for multimedia information according to claim 2, wherein conditions established for retrieving the integrated directory list are defined by data which is memorized beforehand in a memory of the means for retrieving and displaying.

25. A master device for multimedia information according to claim 5, wherein conditions established for retrieving the integrated directory list are defined by data which is memorized beforehand in a memory of the means for retrieving and displaying.

26. A computer program for managing files of a slave device for multimedia information connected via a network to a master device for multimedia information,
wherein the master device comprising:
means for generating a self directory list by retrieving files stored in a memory of the master device;
means for collecting a directory list of the slave device by at least one of retrieving files stored in a memory of the slave device and receiving the directory list generated by the slave device;
means for generating an integrated directory list by integrating the self directory list of the master device and the directory list collected from the slave device; and
means for retrieving and displaying the integrated directory list,
the computer program executing a processor of the slave device in a process comprising:
generating the self directory list by retrieving the files stored in the memory of the slave device; and
distributing the self directory list to the master device via the network.

27. A computer program for managing files of a slave device for multimedia information connected via a network to a master device for multimedia information,
wherein the master device comprising:
means for generating a self directory list by retrieving files stored in a memory of the master device;
means for collecting a directory list of the slave device by at least one of retrieving files stored in a memory of the slave device and receiving the directory list generated by the slave device;
means for generating an integrated directory list by integrating the self directory list of the master device and the directory list collected from the slave device;
means for retrieving and displaying the integrated directory list; and
means for distributing the integrated directory list to the slave device via the network;
the computer program executing a processor of the slave device in a process comprising:
generating the self directory list by retrieving the files stored in the memory of the slave device; and
distributing the self directory list to the master device via the network.

28. A computer program according to claim 9, wherein conditions established for retrieving the integrated directory list are defined by data which is entered via an input slot displayed on the means for retrieving and displaying.

29. A computer program according to claim 12, wherein conditions established for retrieving the integrated directory list are defined by data which is entered via an input slot displayed on the means for retrieving and displaying.

30. A computer program according to claim 9, wherein conditions established for retrieving the integrated directory list are defined by data which is memorized beforehand in a memory of the means for retrieving and displaying.

31. A computer program according to claim 12, wherein conditions established for retrieving the integrated directory list are defined by data which is memorized beforehand in a memory of the means for retrieving and displaying.
